(19) United States
(12) Patent Application Publication
(10) Pub. No.: US 2013/0083688 A1
(43) Pub. Date: Apr. 4, 2013

(54) WIRELESS NETWORK SYSTEM

(71) Applicants: Sahar Abdul Aziz Mageed Al-Talib, Kuala Lumpur (MY); Rashid Abdul Haleem Saeed, Kuala Lumpur (MY); Borhanuddin Mohd Ali, Kuala Lumpur (MY); Mazlan Abbas, Kuala Lumpur (MY); Ahmad Helmi Abdul Halim, Kuala Lumpur (MY); Abdul Wahab Abdullah, Kuala Lumpur (MY)

(72) Inventors: Sahar Abdul Aziz Mageed Al-Talib, Kuala Lumpur (MY); Rashid Abdul Haleem Saeed, Kuala Lumpur (MY); Borhanuddin Mohd Ali, Kuala Lumpur (MY); Mazlan Abbas, Kuala Lumpur (MY); Ahmad Helmi Abdul Halim, Kuala Lumpur (MY); Abdul Wahab Abdullah, Kuala Lumpur (MY)

(73) Assignee: MIMOS BERHAD

(21) Appl. No.: 13/125,203

(22) PCT Filed: Oct. 9, 2009
(86) PCT No.: PCT/MY2009/000166

§ 371 Date: Oct. 17, 2012

(30) Foreign Application Priority Data
Oct. 23, 2008 (MY) PI20084227

(51) Int. Cl. H04W 16/00

(52) U.S. Cl. CPC H04W 16/00
USPC 370/254

(57) ABSTRACT

A system for communication in a wireless backhaul environment having a wireless mesh network connected in part to the Internet, comprising a communication topology having WiMAX gateway/base stations with multi-hop capability located at each corner, and communication cells each having a relay station and mobile nodes communicating to each other using WiMAX wireless technology, wherein the communication cells are arranged to be connected to each other in a grid fabric.

### FIELD OF THE INVENTION

The present invention relates to a system for communication in a wireless backhaul environment having wireless mesh networks connected in part to the Internet.

### BACKGROUND OF THE INVENTION

Internet connection in wireless mesh networks is satisfactory to cover limited range of communication. The Internet implicate addressing scheme of the wireless mesh networks.

When the wireless mesh networks are not connected to. the Internet, the addressing scheme can be flatten such that all nodes do not necessarily need to have the same logical Internet Protocol (IP) subnet. When the wireless mesh networks are connected to the Internet, nodes are required to have a topologically correct and globally routable IP address if the use of network address translation (NAT) is to be avoided.

To provide a multicast routing in hybrid wireless mesh networks, the implications of address management are stronger. This is because the standardized multicast routing protocols used in fixed IP networks rely on the assumption of topologically correct IP addresses. For instance, multicast access routers usually perform a process called Reverse Path Forwarding-check on every incoming packet.

The process drops any packet which arrives at an interface which that router would not use to reach the source of the packet. Thus, address auto-configuration is an important element for a fully integrated and seamless multicast interworking for wireless mesh networks that are connected to Internet.

Classical mechanism for address auto-configuration in traditional Internet connection is not feasible for wireless mesh networks because of their multi-hop characteristic. The mechanism used for address auto-configuration should allow wireless mesh nodes to discover routes towards the gateways. Therefore, address auto-configuration and gateway discovery systems must interoperate with routing protocols used within wireless mesh network.

It is an object of the present invention to provide a system and method for communication in wireless mesh networks for increasing the network throughput and wide coverage of communication which alleviate the above limitation.

### SUMMARY OF THE INVENTION

According to the present invention, a system for communication in wireless backhaul environment having wireless mesh network connected in part to the Internet comprising a communication topology. The communication topology comprises communication cells each having a relay station and mobile nodes communicating to each other using 802.16j wireless technology wherein the cells is arranged in a grid fabric within the communication topology.

The system for communication in wireless backhaul environment having wireless mesh network connected in part to the Internet use WiMAX (Worldwide Interoperability for Microwave Access) gateways (GWs)/base stations (BSs), relay stations (RSs), and combination of mesh and IP nodes.

The system for communication in wireless backhaul environment having wireless mesh network connected in part to the Internet uses address auto- configuration system combined with gateway discovery system and must interoperate with multicast routing protocols used within the wireless mesh network.

According to the present invention, a cell is a WiMAX wireless vicinity of unity square kilometer is provided for the system. The cells are arranged to form a grid fabric of network for wireless communication. The cell comprises of a relay station which supports the wireless mesh nodes in the cell and exchanges the routing information in between the other cells. In this way the network throughput can be extended and the number of nodes per grid fabric of the network.

### BRIEF DESCRIPTION OF THE DRAWINGS

The present invention will be described by way of example only, with reference to the accompanying drawings in which:

FIG. 1 is a diagram showing integrated multicast scenario;

FIG. 2 is a diagram showing a communication system with the integrated multicast scenario of FIG. 1;

FIG. 3 is a diagram showing source in mesh domain;

FIG. 4 is a diagram showing receiver in mesh domain; and

FIG. 5 is a flow diagram for the communication system of FIG. 2.

### DESCRIPTION OF THE PREFERRED EMBODIMENT

Preferably, a system for communication in wireless backhaul environment having wireless mesh network connected in part to the Internet is provided to have a communication topology having WiMAX gateway/base station with multi-hop capability located at each corner. The topology has a plurality of communication cells each having relay station and mobile nodes communicating to each other using WiMAX wireless technology wherein the communication cell is arranged to be connected to each other in a grid fabric.

The system for communication in wireless backhaul environment having wireless mesh network connected in part to the Internet comprises the use of address auto-configuration system combined with gateway discovery system and must interoperate with the multicast routing protocols used within the wireless mesh network.

According to the present invention, a cell defines a WiMAX wireless vicinity of unity square kilometer is provided to the system. The cells are arranged to form a grid fabric of network for wireless communication. The cell comprises of a relay station which supports the wireless mesh nodes in the cell and exchanges the routing information in between the other cells. In this way the network throughput can be extended and the number of nodes per grid fabric of the network.

Preferably, a system and method for communication in wireless mesh networks connected to the internet use 802.16e and 802.16j wireless technologies. The topology may utilizes any future wireless technology with the same capability of 802.16e wireless technology and any future wireless technology with multi-hop capability of 802.16j wireless technology.

The grid fabric or topology of N×M square kilometers is provided to the system, wherein N and M can be of any integer number and N can be equal to M. WiMAX base stations with multi hop capability is located at each corner of the topology with WiMAX radio range as a network backbone.

The base stations (BSs) are connected to the Internet through a gateway (GW). A community network is provided comprising of a set of N x M cells each cell occupies an area of unity square kilometer wherein the N and M are integer number and can be equal.

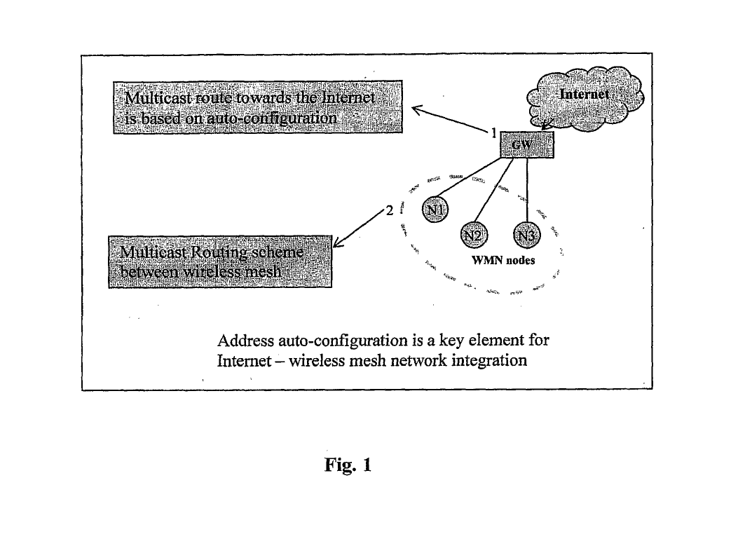

Each cell comprises of one relay station (RS) located in the center of the cell having 802.16j technology and a WiMAX radio range. The neighbouring cells are mesh connected. The relay stations will relay signals between Mobile stations (MSs) and gateway (GW)/base stations (BSs) (i.e. Internet) within the same cell as well as exchanging information and control signals with other cells. The internal traffic within the cells is assumed to be 70% and the external traffic between cells and the Internet is assumed to be 30%. FIG. 1 partially shows integrated multicast scenario where address auto-configuration is a key element of the integration.

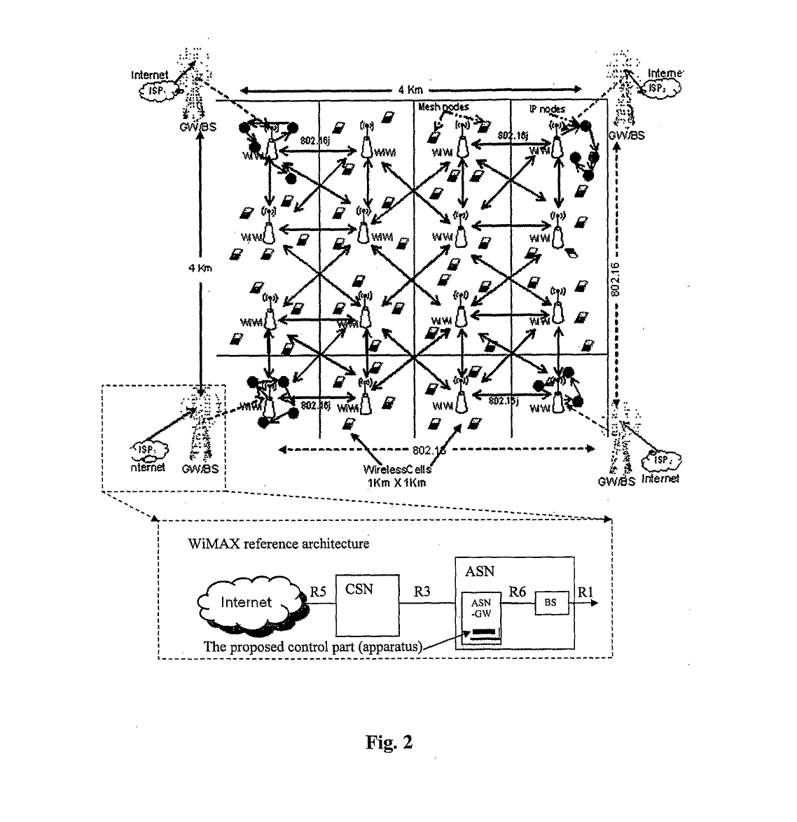

The architecture of the communication system is illustrated in FIG. 2. As shown if FIG. 2, the grid fabric comprises 16 cells (4×4). The system of the present invention is of type hybrid wireless mesh network with prefix continuity.

As a result, the system will be benifited in one part of the Internet service provisioning such as Hypertext Transfer Protocol (HTTP), IPTV, Voice over Internet Protocol (VoIP) and in the other part of multicast service provisioning such as video streaming, short message services (SMS), video conferring, etc.

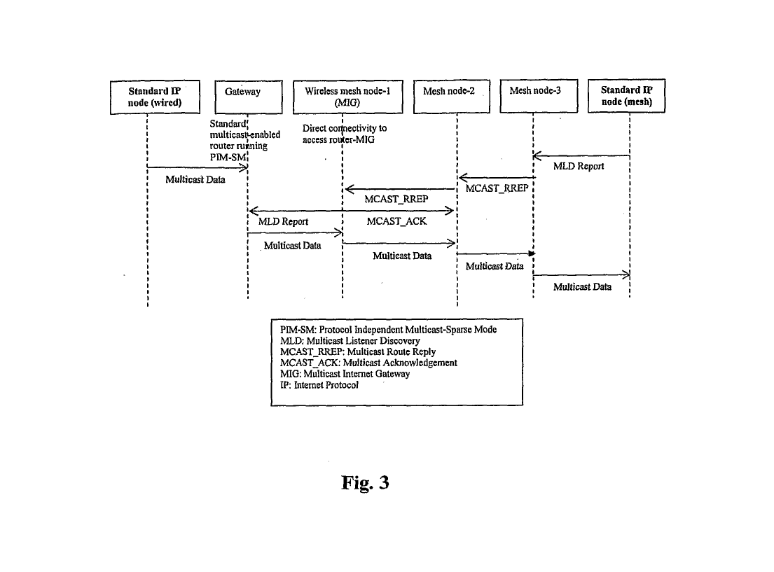

FIG. 3 shows the interaction of the nodes in a scenario when the source is in the mesh domain and the receiver in the Internet vicinity. The Gateway is a standard multicast-enabled router running Protocol Independent Multicast-Sparse Mode (PIM-SM). Wireless mesh nodes are wireless routers and the IP nodes are standard Internet hosts. One of the IP nodes is in the wired network and the other one is connected to the wireless mesh.

The interoperation with gateways is performed by wireless mesh nodes which have direct connectivity to access routers (i.e. Multicast Internet Gateways).

The reception of a Multicast Listener Discovery (MLD) Query or Internet Group Management Protocol (IGMP) Query message can be used by those nodes to detect that they must act as multicast internet gateways. If that is the case, they must send IGMP or MLD reports to the access router, to inform about which multicast groups have interested receivers within the mesh. Multicast Internet gateways know this information because receivers within the mesh will send IGMP or MLD reports to their selected wireless mesh node, which will in turn create a multicast path towards the gateway following its best path towards the gateway based on prefix continuity. Of course, those paths are created in advance by the periodic gateway advertisements explained before and all wireless mesh nodes know their parent in the prefix continuity tree.

The multicast internet gateway is also responsible for joining all the multicast groups with active senders within the wireless mesh and to forward all the multicast traffic towards the gateway so that it can detect that sources and execute the IP multicast routing specific functions.

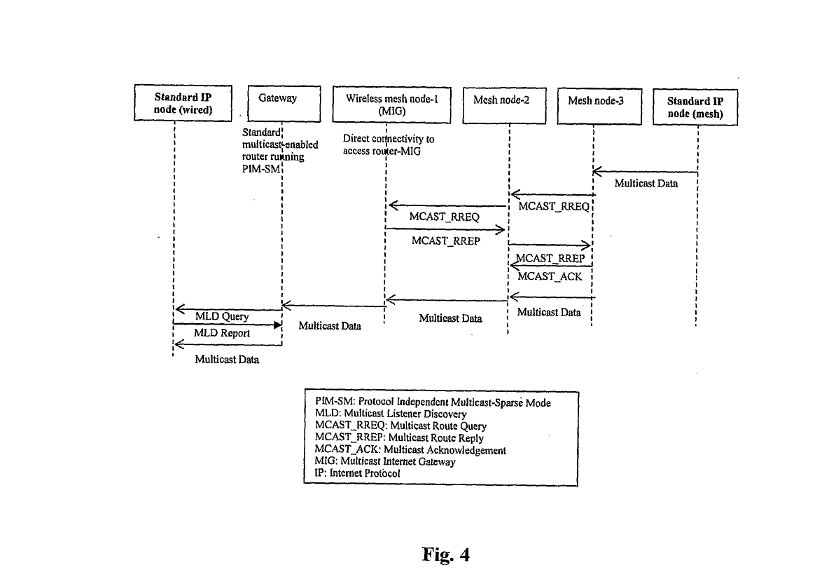

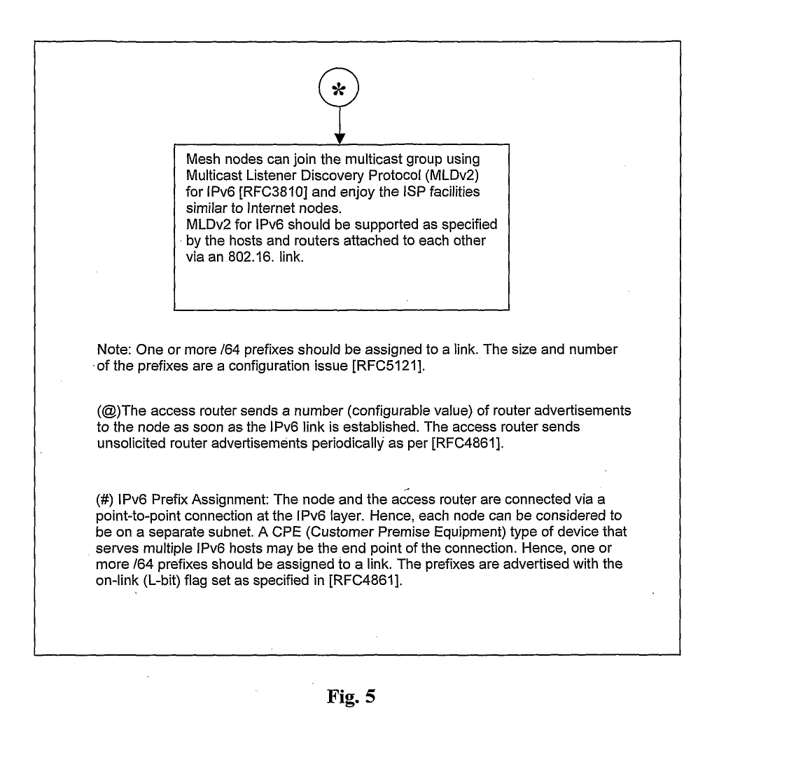

FIG. 4 shows the interaction of the protocol in a scenarios when the receiver is in the mesh domain and the source in the Internet vicinity. Similar multicast and membership messages are used for Internet and mesh nodes interaction with the gateways.

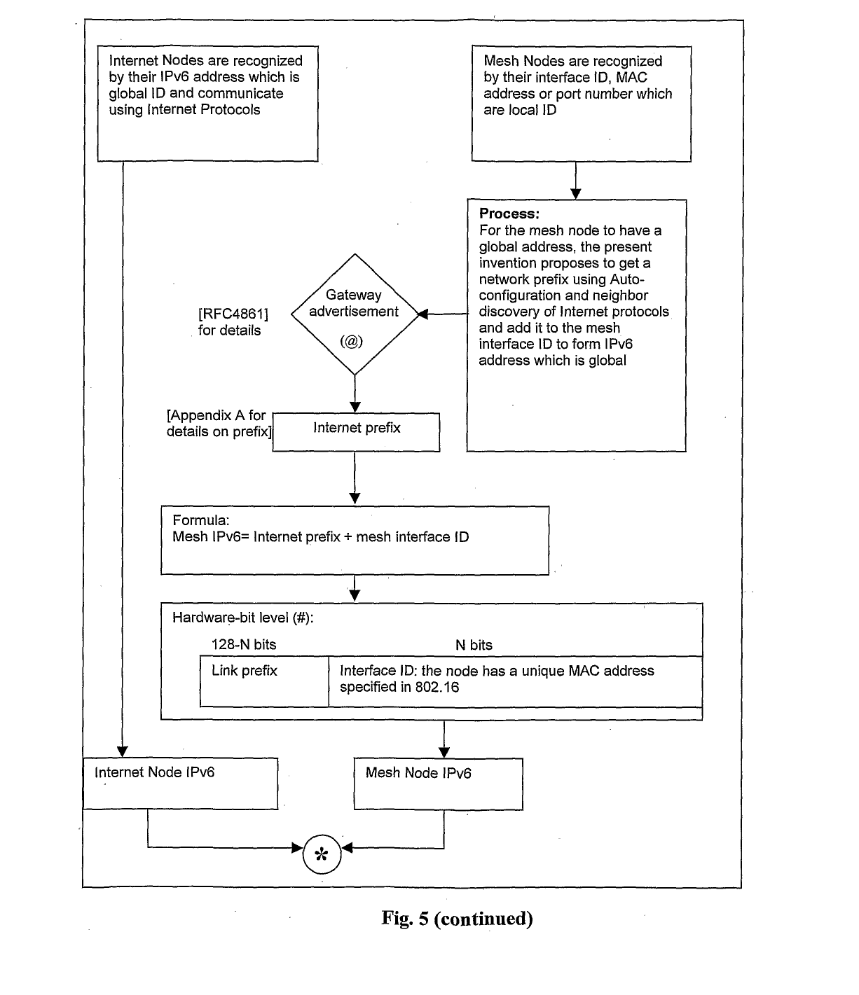

As shown in FIG. 5, mesh Nodes are recognized by their interface ID, MAC address or port number which are local ID. For the mesh node to have a global address, the present invention proposes to get a network prefix using Auto-configuration and neighbor discovery of Internet protocols and add it to the mesh interface ID to form IPv6 address which is global. The process of obtaining the global address for mesh nodes from the local identification/interface ID/MAC address/etc besides the formula used and the reference specifications all are depicted in FIG. 5.

The wireless mesh nodes interact with IP nodes and multicast routers using Multicast Listener Discovery Protocol (MLD) for IPv6 or Internet Group Management Protocol (IGMP) messages for IPv4. The wireless mesh nodes use the multicast routing messages based on the membership information obtained.

The gateways are one hop away from the relay station of the closest cell. The main requirements to support Internet-wireless mesh network connectivity comprises of addresses assigned to mobile nodes need to be topologically correct and use prefix continuity further comprises of group membership messages using maximum Time-To-Leave (TTL).

The wireless mesh network must guarantee that the multicast router joins the multicast group for efficient multicast path between the gateways and sources in the mesh as shown in FIG. 3. The communication between multiple subnetworks and wireless mesh network using different prefixes performed via the gateways and multicast routing protocol used in wired network.

1. A system for communication in a wireless backhaul environment having a wireless mesh network connected in part to the Internet, comprising:
a communication topology having WiMAX gateway/base stations with multi-hop capability located at each corner; and
communication cells each having a relay station and mobile nodes communicating to each other using WiMAX wireless technology, wherein the communication cells are arranged to be connected to each other in a grid fabric.

2. A system as claimed in claim 1, wherein the grid fabric comprises a communication topology of N×M square kilometer wherein N and M are integer numbers and could be equal.

3. A system as claimed in claim 1, wherein the base stations are arranged at each corner of the topology with WiMAX radio range as a network backbone.

4. A system as claimed in claim 1, wherein the topology utilizes 802.16e wireless technology and 802.16j wireless technology.

5. A system as claimed in claim 1, wherein each communication cell occupies an area of approximately one square kilometer having one relay station located in the center of the cell, each relay station having 802.16j wireless technology

6. A system as claimed in claim 1, wherein the base stations are connected to the Internet through a gateway.

7. A system as claimed in claim 1, wherein the communication is a hybrid wireless mesh network with prefix continuity.

8. A system as claimed in claim 1, wherein the communication topology uses an address auto-configuration system combined with a gateway discovery system and interoperates with the multicast routing protocols for topologically assigning address to wireless nodes within the grid fabric of the communication topology; and uses prefix continuity for all wireless routing system with the same gateway.

9. A system as claimed in claim 8, wherein the address auto-configuration system operates on network prefixes advertised by the gateways.

10. A system as claimed in claim 9, wherein the address auto-configuration system is comprised of wireless mesh nodes generating IPv6 address from an interface identifier and the network prefix advertised by the gateways.

11. A system as claimed in claim 10, wherein the gateway discovery system floods advertisement to all wireless nodes.

12. A system as claimed in claim 9, wherein the wireless mesh nodes interact with IP nodes and multicast routers using Multicast Listener Discovery (MLD) or Internet Group Management Protocol (IGMP) messages.

13. A system as claimed in claim 9, wherein the wireless mesh nodes use the multicast routing messages based on the membership messages.
